(19) United States
(12) Patent Application Publication
(10) Pub. No.: US 2022/0248601 A1
(43) Pub. Date: Aug. 11, 2022

(54) LAWN MOWER

(71) Applicant: Nanjing Chervon Industry Co., Ltd., Nanjing (CN)

(72) Inventors: Yang Nie, Nanjing (CN); Toshinari Yamaoka, Nanjing (CN)

(21) Appl. No.: 17/585,867

(22) Filed: Jan. 27, 2022

(30) Foreign Application Priority Data
Feb. 10, 2021 (CN) 202110182281.7

(51) Int. Cl. A01D 43/08; A01D 34/68; A01D 34/76

(52) U.S. Cl. CPC A01D 43/087; A01D 34/68; A01D 2101/00; A01D 43/088; A01D 34/76

(57) ABSTRACT

A lawn mower includes a blade, a deck assembly, and a drive assembly. The deck assembly is formed with an accommodation cavity configured to at least partially accommodate the blade. The drive assembly includes a drive shaft configured to drive the blade to rotate about a rotation axis. The deck assembly includes a top wall, a side wall, and a protrusion. The top wall is formed with a through hole for the drive shaft to pass through. The side wall is connected to a periphery of the top wall. The protrusion portion is at least partially disposed on the side wall and protrudes from the side wall. A projection of the protrusion portion on a plane perpendicular to the rotation axis is at least partially located within a projection of a cutting region of the blade on the plane. The lawn mower has a strong grass-shredding capability.

### RELATED APPLICATION INFORMATION

This application claims the benefit of Chinese Application No. 202110182281.7, filed on Feb. 10, 202, the disclosure of which is incorporated herein by reference in its entirety.

### TECHNICAL FIELD

The present disclosure relates to garden tools and, in particular, to a lawn mower.

### BACKGROUND

As a garden tool, a lawn mower is a mechanical tool for mowing lawns and vegetation. A household rotary mower mows lawns and vegetation efficiently through high-speed rotation of blades, thereby saving a user's operation time and a lot of manpower. At present, a common household lawn mower mainly has a grass-shredding mode, a grass-collecting mode, and a grass-discharging mode. In the grass-shredding mode, grass clippings after being cut are shredded so that grass shreds fall to roots of grass bundles and become nourishment. In the grass-collecting mode, the grass clippings are collected into a grass collecting basket in time by using an airflow formed through the rotation of blades. In the grass-discharging mode, the grass clippings are directly discharged from a grass outlet by using the airflow formed through the rotation of blades.

In the grass-shredding mode, since the grass clippings after cutting fall directly on the lawn, when relatively lush vegetation is mowed, if the grass clippings are relatively large in volume and cannot be shredded in time, the grass clippings cannot easily fall to grass roots and are laid unevenly. In the grass-collecting mode and the grass-discharging mode, if the grass clippings are relatively large in volume, the grass clippings may fall or block an air duct and the grass outlet, which is not conducive to the collection or discharge of the grass clippings.

### SUMMARY

To solve defects in the existing art, an object of the present disclosure is to provide a lawn mower with which grass is shredded with high quality and from which less grass falls.

To achieve the preceding object, the present disclosure adopts technical solutions described below.

A lawn mower includes a blade, a deck assembly, and a drive assembly. The blade is configured to implement a cutting function. The deck assembly is formed with an accommodation cavity configured to accommodate at least part of the blade. The drive assembly includes a drive shaft configured to drive the blade to rotate about a rotation axis. The deck assembly includes a top wall, a side wall, and a protrusion portion. The top wall is formed with a through hole for the drive shaft to pass through. The side wall is connected to a periphery of the top wall. The protrusion is at least partially disposed on the side wall and protrudes from the side wall. The blade has a blade tip farther from the rotation axis. A distance between the blade tip and the rotation axis is a cutting radius. A circular region with the rotation axis as a center and the cutting radius as a radius is defined as a cutting region. A projection of the protrusion portion on a plane perpendicular to the rotation axis is at least partially located within a projection of the cutting region on the plane.

In an example, a maximum width of an overlapping part of the projection of the protrusion portion on the plane perpendicular to the rotation axis and the projection of the cutting region on the plane is greater than or equal to 10 mm and less than or equal to 20 mm.

In an example, a coordinate system is established on the plane perpendicular to the rotation axis, where a projection of the rotation axis on the plane is an origin of the coordinate system, a first straight line extending along a front-and-rear direction is an x-axis of the coordinate system, a direction extending along the first straight line toward a rear side of the lawn mower is a positive direction of the x-axis, a second straight line extending along a left-and-right direction is a y-axis of the coordinate system, a direction extending along the second straight line toward a right side of the lawn mower is a positive direction of the y-axis, and the projection of the protrusion portion on the plane is located in a first quadrant and a fourth quadrant of the coordinate system.

In an example, a maximum width of the projection of the protrusion portion on the plane perpendicular to the rotation axis in a direction of the x-axis is greater than or equal to 2% of a diameter of the accommodation cavity and less than or equal to 6% of the diameter of the accommodation cavity.

In an example, the protrusion portion is located above the blade tip in a direction parallel to the rotation axis.

In an example, a height difference between the protrusion portion and the blade tip is less than or equal to 10 mm.

In an example, an angle between a line from one end of the projection of the protrusion portion on the plane perpendicular to the rotation axis to a projection of the rotation axis on the plane and a line from another end of the projection of the protrusion portion on the plane and the projection of the rotation axis on the plane is greater than or equal to 60° and less than or equal to 180°.

In an example, the protrusion portion and the side wall are integrally formed.

In an example, the deck assembly further includes a grass outlet cover and a plug, where the protrusion portion protrudes from the side wall, the grass outlet cover, and the plug.

In an example, a part of the protrusion portion is integrally formed with the side wall, a part of the protrusion portion is integrally formed with the grass outlet cover, and another part of the protrusion portion is integrally formed with the plug.

The present disclosure has the following beneficial effects: the protrusion portion is disposed on the side wall of the deck assembly so that grass clippings after cutting are not easy to fall and are reflected onto the blade for repeated cutting, thereby shredding the grass more thoroughly and laying the grass more evenly.

### BRIEF DESCRIPTION OF DRAWINGS

FIG. 1 is a perspective view of a lawn mower according to an example;

FIG. 2 is a perspective view of a main body of the lawn mower in FIG. 1;

FIG. 3 is a sectional view of the main body of the lawn mower in FIG. 2;

FIG. 4 is an exploded view of a deck assembly of the lawn mower in FIG. 2;

FIG. 5 is a perspective view of a grass outlet cover and a plug of the lawn mower in FIG. 4;

FIG. 6 is a perspective view of a main body of a lawn mower according to another example; and

FIG. 7 is a schematic view of a deck assembly according to an example.

### DETAILED DESCRIPTION

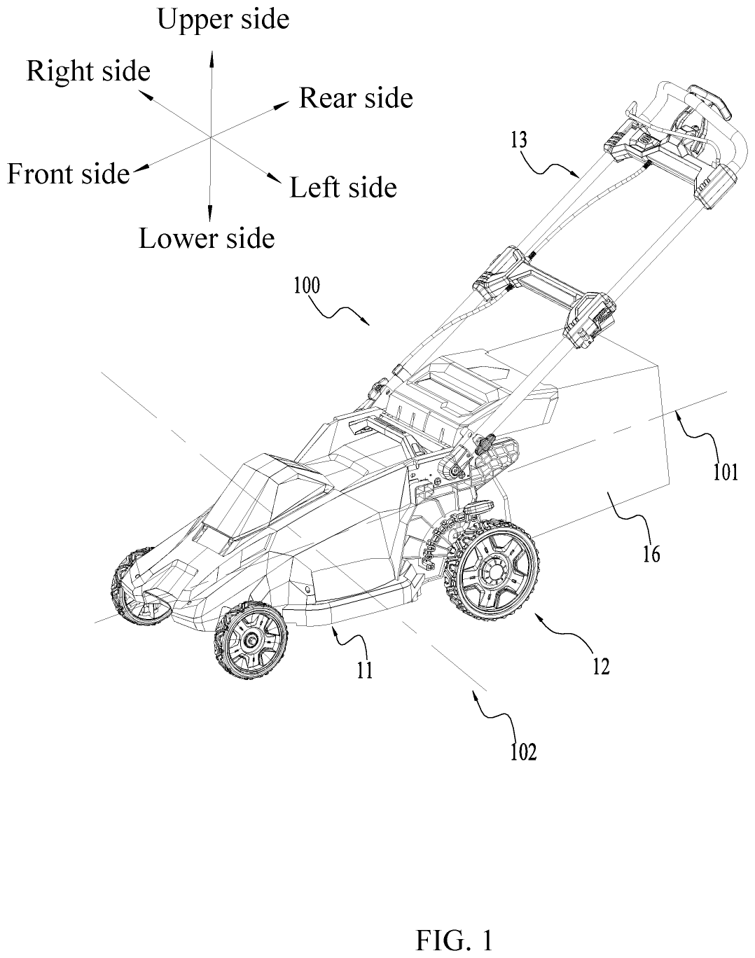

A lawn mower 100 shown in FIG. 1 may be pushed and operated by a user to mow lawns, vegetation, and the like. The lawn mower 100 includes a main body 11, a moving assembly 12, an operating assembly 13, a grass collecting basket 16, and a power supply device. The main body 11 is used for installation of the moving assembly 12, the operating assembly 13, the grass collecting basket 16, and the power supply device. The preceding assemblies and devices are reasonably installed to parts of the main body 11. To facilitate the description of technical solutions, a front side, a rear side, a left side, a right side, an upper side, and a lower side shown in FIG. 1 are defined, and a first straight line 101 extending along a front-and-rear direction and a second straight line 102 extending along a left-and-right direction are defined.

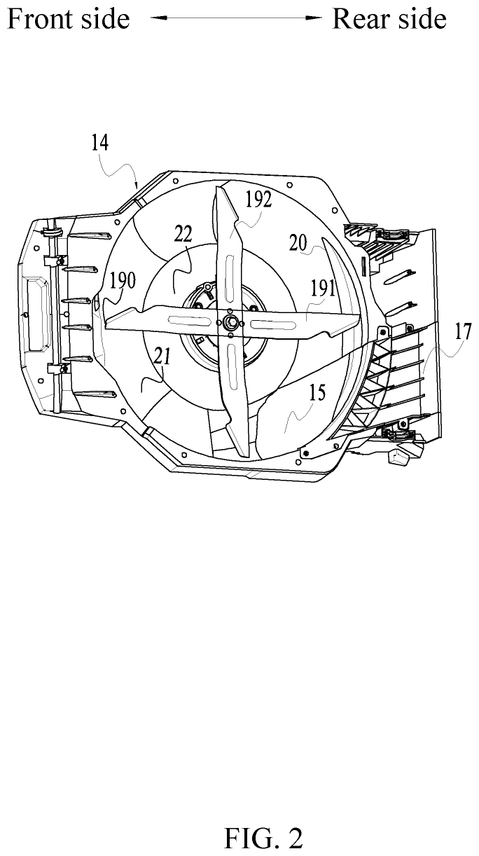

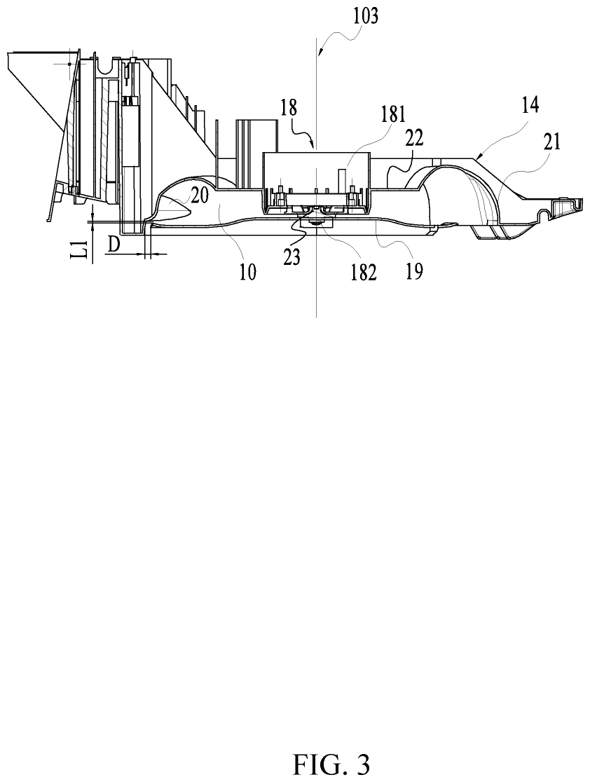

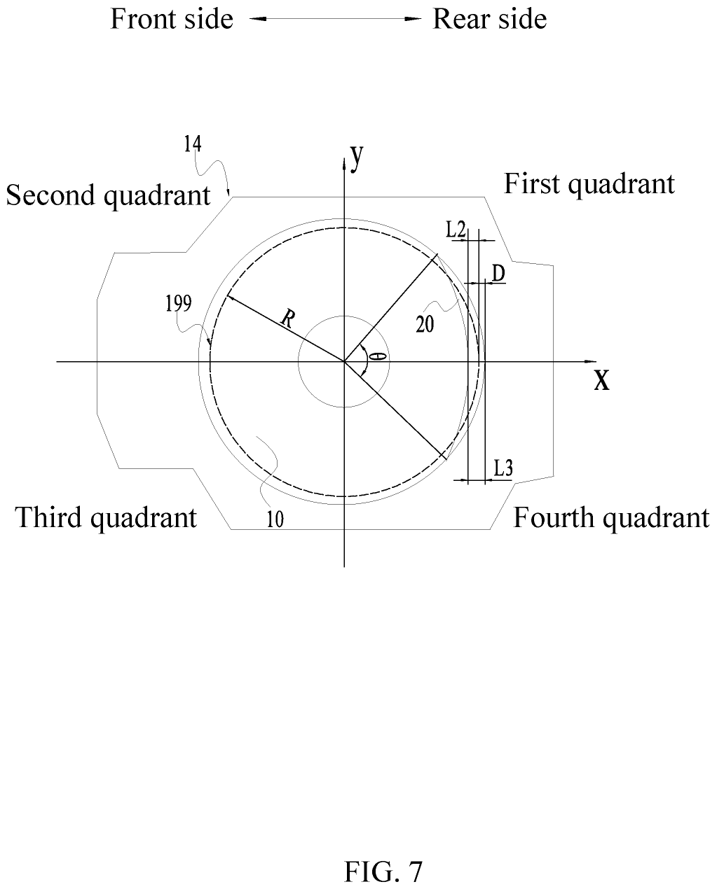

Referring to FIGS. 2 and 3, the main body 11 of the lawn mower 100 includes a deck assembly 14, a drive assembly 18, and a blade assembly 19. In this example, the drive assembly 18 includes a motor 181 and further includes a drive shaft 182, where the drive shaft 182 is a motor shaft. An accommodation cavity 10 is formed under the deck assembly 14 to accommodate the blade assembly 19. The motor 181 and the blade assembly 19 are installed to the deck assembly 14 so that the motor 181 can drive, through the drive shaft 182, the blade assembly 19 to rotate about a rotation axis 103 in the accommodation cavity 10. In other examples, the drive assembly 18 may further include a transmission assembly for power transmission between the motor 181 and the blade assembly 19. An output shaft of the transmission assembly may be regarded as the drive shaft 182 of the drive assembly 18, and the blade assembly 19 may be directly installed to the drive shaft 182. The blade assembly 19 includes a first blade 191 and a second blade 192. In other examples, the blade assembly 19 may also include only one blade. The specific implementation of the blade assembly 19 is not limited in the present application. Apart of the blade assembly 19 farther from the rotation axis 103 is defined as a blade tip 190. The blade tip 190 may be a single point or a collection of multiple points. The specific shape of the blade tip 190 is not limited in the present application. A distance between the blade tip 190 and the rotation axis 103 is defined as a cutting radius R, and a circular region with the rotation axis 103 as a center and the cutting radius R as a radius is defined as a cutting region 199 (shown in FIG. 7).

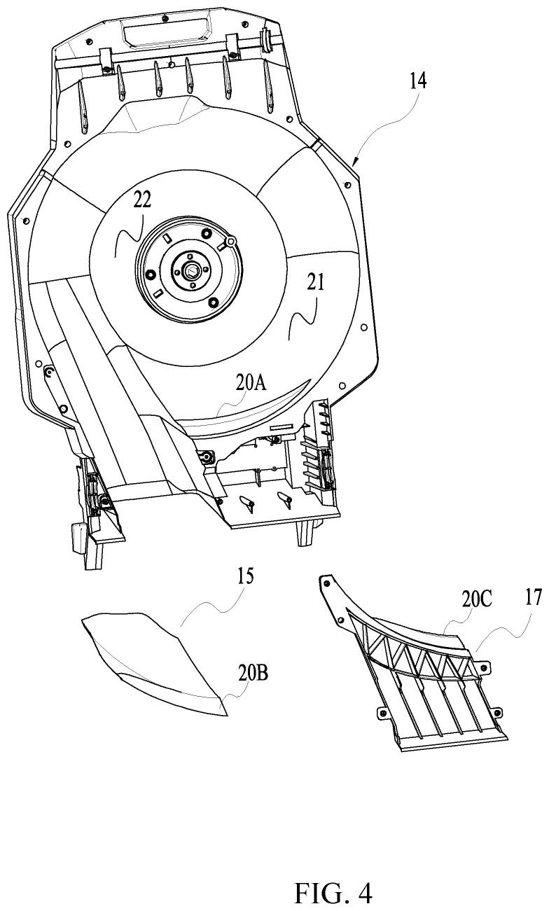

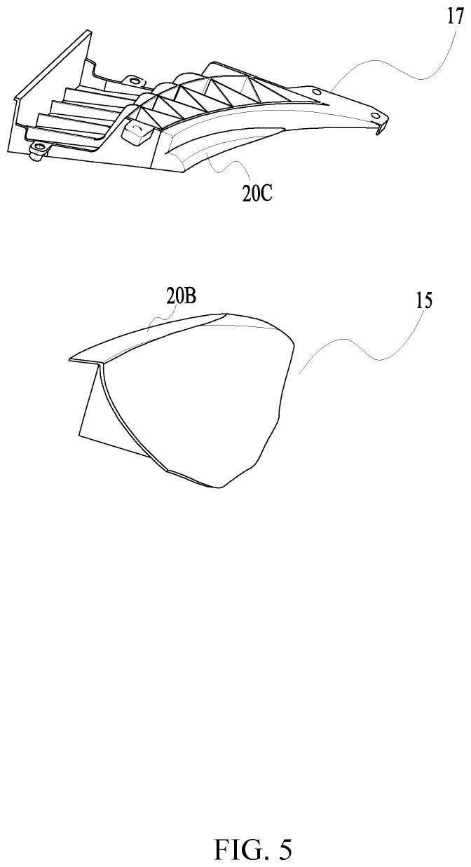

Referring to FIGS. 4 and 5, the deck assembly 14 includes a top wall 22 and a side wall 21. The top wall 22 is formed with a through hole 23 for the drive shaft 182 to pass through, the side wall 21 is connected to a periphery of the top wall 22 so as to form the semi-open accommodation cavity 10, and the top wall 22 and the side wall 21 may be integrally formed. In an example, the deck assembly 14 further includes a grass outlet cover 17 and a plug 15, and the grass outlet cover 17 and the plug 15 are installed on a rear side of the deck assembly 14 (as shown in FIG. 2, a front side and the rear side of the deck assembly 14 are defined the same as those of the lawn mower 100 in FIG. 1). The plug 15 is used for switching between a grass-shredding mode, a grass-collecting mode, and a grass-discharging mode. When the plug 15 is not installed to the lawn mower 100, if the grass collecting basket 16 is installed to the lawn mower 100, the lawn mower 100 is in the grass-collecting mode. At this time, grass clippings after cutting of the lawn mower 100 can be collected by the grass collecting basket 16. If the grass collecting basket 16 is not installed to the lawn mower 100, the lawn mower 100 is in the grass-discharging mode. At this time, the grass clippings after cutting of the lawn mower 100 may be guided in conjunction with another guiding component to be discharged. When the plug 15 is installed to the lawn mower 100, the lawn mower 100 is in the grass-shredding mode, and the grass collecting basket 16 is removed. At this time, the grass clippings after cutting of the lawn mower 100 are repeatedly cut and fall to roots of grass bundles. The grass outlet cover 17 is provided with reinforcing ribs that can cope with the impact from the grass clippings in the grass-collecting mode or the grass-discharging mode.

A protrusion portion 20 extending transversely and protruding toward the drive shaft 182 is formed on an inner side of the side wall 21 of the deck assembly 14. The function of the protrusion portion 20 is to reflect grass that has been cut by the blade assembly 19 onto the blade assembly 19 for repeated cutting, thereby shredding the grass more thoroughly and spreading the grass more evenly. It can be seen from the sectional view shown in FIG. 3 that a height of the protrusion portion 20 is slightly higher than a height of the blade tip 190, that is, the protrusion portion 20 is located above the blade tip 190 in a vertical direction. It is to be noted that since the blade assembly 19 itself has certain undulation and a certain thickness, what is compared here is a positional relationship between the blade tip 190 and the protrusion portion 20 in a direction parallel to the rotation axis 103 after the blade assembly 19 is installed in place, which is not a positional relationship between the entire blade assembly 19 and the protrusion portion 20. Moreover, a height difference L1 between the protrusion portion 20 and the blade tip 190 is less than or equal to 10 mm; or the height difference L1 between the protrusion portion 20 and the blade tip 190 is less than or equal to 6 mm. In an example, the height difference L1 between the protrusion portion 20 and the blade tip 190 is 3 mm. At the same time, in a horizontal direction, a projection of the protrusion portion 20 on a plane perpendicular to the rotation axis 103 at least partially falls within the cutting region 199 of the blade assembly 19. Referring to FIG. 7, specifically, the projection of the protrusion portion 20 on the plane perpendicular to the rotation axis 103 of the blade assembly 19 partially overlaps with a projection of the cutting region 199 of the blade assembly 19 on the plane, and a maximum width L2 of an overlapping part is greater than or equal to 5 mm and less than or equal to 25 mm; or the maximum width L2 of the overlapping part is greater than or equal to 10 mm and less than or equal to 20 mm. In an example, the maximum width L2 of the overlapping part is substantially twice a shortest linear distance D between the blade tip 190 and the side wall 21 of the deck assembly 14. In an example, the maximum width L2 of the overlapping part is 16 mm. In this manner, above the blade tip 190, the protrusion portion 20 and the blade tip 190 together form a relatively narrow channel. When no protrusion portion 20 is provided, a gap between the deck assembly 14 and the blade tip 190 is relatively large so that the grass may easily fall. However, when the protrusion portion 20 and the blade tip 190 together form the relatively narrow channel, the grass clippings after cutting are not easy to fall so that less grass falls and the grass clippings can repeatedly fall onto the blade assembly 19 for repeated cutting, thereby shredding the grass more thoroughly and laying the grass more evenly to the roots of the grass bundles.

It is to be noted that since most household rotary mowers can switch between the grass-shredding mode, the grass-collecting mode, and the grass-discharging mode, the deck assembly 14 of each of most household rotary mowers further includes structures such as the plug 15 and the grass outlet cover 17. These structures exist so that an inner surface of the accommodation cavity 10 is composed of multiple structures. Therefore, when the inner surface of the accommodation cavity 10 is specifically composed of multiple structures such as the side wall 21, the plug 15, and the grass outlet cover 17, the protrusion portion 20 also extends to the plug 15 and the grass outlet cover 17. Referring to FIGS. 4 and 5, a part of the protrusion portion 20 is located on the side wall 21, and other parts of the protrusion portion 20 are located on the plug 15 and the grass outlet cover 17 and separately protrude from an edge position of a connection part between the plug 15 and the grass outlet cover 17. Specifically, when the plug 15 and the grass outlet cover 17 are installed to the deck assembly 14, protrusion portions 20B and 20C separately protruding from the edge position of the connection part between the plug 15 and the grass outlet cover 17 have the same height as a protrusion portion 20A on the side wall 21 in the vertical direction so that the protrusion portions 20B, 20C, and 20A are transversely connected into the whole. In an example, the protrusion portion 20A on the side wall 21 is integrally formed with the side wall 21, the protrusion portion 20B on the plug 15 is integrally formed with the plug 15, and the protrusion portion 20C on the grass outlet cover 17 is integrally formed with the grass outlet cover 17. In this manner, the following beneficial effects are achieved: no additional assembly steps are required, and a surface of a whole formed by the protrusion portion 20A and the side wall 21 is smooth so that grass is not easily jammed. In an example, the protrusion portion 20 may also be an independent component and installed to the side wall 21, the plug 15, and the grass outlet cover 17. For example, the protrusion portion 20 is an arc with a radian similar to a radian of the side wall 21 and fixed to the side wall 21, the plug 15, and the grass outlet cover 17 through snaps or screws or in other manners. In this manner, although the side wall 21, the plug 15, and the grass outlet cover 17 are multiple components, the protrusion portion 20 protruding from the side wall 21, the plug 15, and the grass outlet cover 17 is integral so that on the one hand, the protrusion is smooth and the grass is not easily jammed; on the other hand, since the protrusion 20 has more friction with the grass, the separate protrusion 20 may be made of a material different from that of the side wall 21, such as a material with higher abrasion resistance, and the protrusion portion 20 may be replaced separately when necessary.

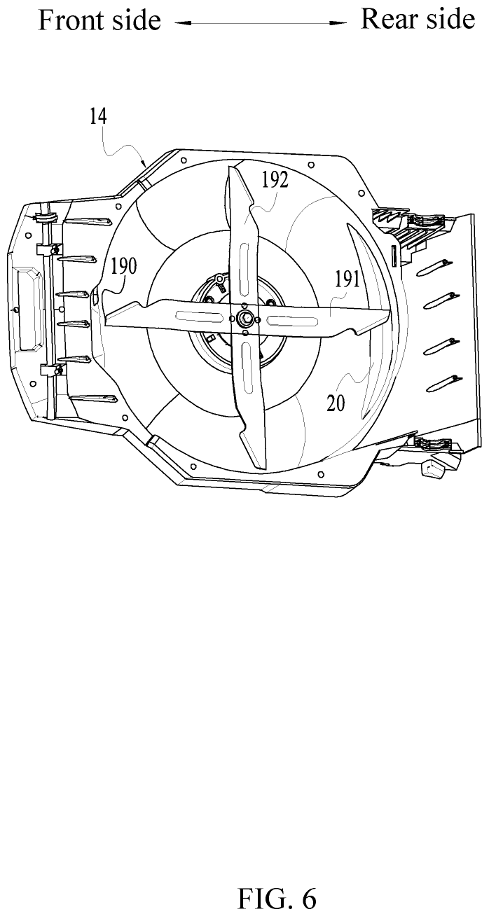

For some lawn mowers with a single function, such as those having only the grass-shredding mode, the inner surface of the accommodation cavity 10 of the blade assembly 19 may be completely composed of only the side wall 21 of the deck assembly 14 instead of other structures such as the plug 15 and the grass outlet cover 17. In this case, the protrusion portion 20 may be completely disposed on the side wall 21, as shown in FIG. 6. In this case, the protrusion portion 20 may be integrally formed with the side wall 21; or the protrusion portion 20 may be a separate component and be fixed to the side wall 21 through the snaps or the screws or in other manners. It is to be understood that the present application shows the operating principle of the protrusion portion 20 and corresponding parameters that make the protrusion portion 20 effective and accordingly shows the best position of the protrusion portion 20 relative to the deck assembly 14 and the blade assembly 19 of the lawn mower. However, other specific structures at a position where the protrusion portion 20 is located are not limited. In other words, for a lawn mower with the deck assembly 14 with a simple structure, the protrusion portion 20 may only protrude from the side wall 21; for a lawn mower with the deck assembly 14 with a relatively complex structure, the protrusion portion 20 may protrude from the side wall 21 and the plug 15, may protrude from the side wall 21 and the grass outlet cover 17, or may protrude from other components in addition to the side wall 21, the plug 15, and the grass outlet cover 17, which depends on the specific structure of the deck assembly 14. In addition, when the protrusion portion 20 protrudes from multiple components, the protrusion portion 20 may be integrally formed with these components or may be separately manufactured and fixed to these components.

When the lawn mower 100 is normally moving forward and mowing grass, the grass clippings mainly fall from the rear of the main body 11, that is, fall from a gap between the blade tip 190 and a rear part of the deck assembly 14. Therefore, preferably, the protrusion portion 20 protrudes from the side wall 21 on the rear side of the deck assembly 14; if the plug 15 and the grass outlet cover 17 are provided, since the plug 15 and the grass outlet cover 17 are generally installed on the rear side of the deck assembly 14, the protrusion portion 20 protrudes from the side wall 21 on the rear side of the deck assembly 14 and the side of the plug 15 and the grass outlet cover 17. For accuracy of description, a coordinate system is established on the plane perpendicular to the rotation axis 103. As shown in FIG. 7, a projection of the rotation axis 103 on the plane is an origin of the coordinate system, the first straight line 101 extending along the front-and-rear direction is an x-axis of the coordinate system, a direction extending along the first straight line 101 toward a rear side of the lawn mower 100 is a positive direction of the x-axis, the second straight line 102 extending along the left-and-right direction is a y-axis of the coordinate system, a direction extending along the second straight line 102 toward a right side of the lawn mower 100 is a positive direction of the y-axis, and a first quadrant, a second quadrant, a third quadrant, and a fourth quadrant shown in FIG. 7 are defined according the x-axis and the y-axis. Regardless of whether the protrusion portion 20 protrudes from the side wall 21 or protrudes from the side wall 21, the plug 15, and the grass outlet cover 17, as seen from the projection of the protrusion portion 20 on the plane perpendicular to the rotation axis 103, the protrusion portion 20 is located in the first quadrant and the fourth quadrant of the coordinate system. In an example, the protrusion portion 20 protrudes at different thicknesses, that is, the protrusion portion 20 is thick in the middle, thin at both ends, and crescent-shaped so that the protrusion portion is relatively smooth and the grass will not be jammed at the edge of the protrusion portion. Even if the projection of the protrusion portion 20 on the plane perpendicular to the rotation axis 103 of the blade assembly 19 is to partially overlap with the projection of the cutting region 199 of the blade assembly 19 on the plane, a maximum thickness L3 of the protrusion 20 needs to be limited to a certain extent. The maximum thickness L3 of the protrusion portion 20 may be regarded as a maximum width L3 of the projection of the protrusion portion 20 on the plane perpendicular to the rotation axis 103 of the blade assembly 19 in a direction of the x-axis and is equal to a sum of the shortest linear distance D between the blade tip 190 and the side wall 21 of the deck assembly 14 and the maximum width L2 of the overlapping part of the projection of the protrusion portion 20 on the plane perpendicular to the rotation axis 103 of the blade assembly 19 and the projection of the cutting region 199 on the plane. In an example, the maximum width L3 of the projection of the protrusion portion 20 on the plane perpendicular to the rotation axis 103 of the blade assembly 19 in the direction of the x-axis is substantially three times the shortest linear distance D between the blade tip 190 and the side wall 21 of the deck assembly 14. In an example, the shortest linear distance D between the blade tip 190 and the side wall 21 of the deck assembly 14 is about 8 mm, the maximum width L2 of the overlapping part of the projection of the protrusion portion 20 on the plane perpendicular to the rotation axis 103 of the blade assembly 19 and the projection of the cutting region 199 on the plane is about 16 mm, and the maximum width L3 of the projection of the protrusion portion 20 on the plane perpendicular to the rotation axis 103 of the blade assembly 19 in the direction of the x-axis is about 24 mm. In an example, the maximum width L3 of the projection of the protrusion portion 20 on the plane perpendicular to the rotation axis 103 of the blade assembly 19 in the direction of the x-axis is greater than or equal to 2% of a diameter of the accommodation cavity 10 of the deck assembly 14 and less than or equal to 6% of the diameter of the accommodation cavity 10 of the deck assembly 14. In an example, the maximum width L3 of the projection of the protrusion portion 20 on the plane perpendicular to the rotation axis 103 of the blade assembly 19 in the direction of the x-axis is about 4% of the diameter of the accommodation cavity 10 of the deck assembly 14. At the same time, in order that less grass falls and the grass clippings are repeatedly cut, a certain requirement is put on a length at which the entire protrusion portion 20 extends transversely on the deck assembly 14. For example, an angle θ between a line from one end of the projection of the protrusion portion 20 on the plane perpendicular to the rotation axis 103 of the blade assembly 19 to the projection of the rotation axis 103 on the plane and a line from the other end of the projection of the protrusion portion 20 on the plane to the projection of the rotation axis 103 on the plane is greater than or equal to 60°. If the protrusion portion 20 extends transversely on the deck assembly 14 at too large a length, the airflow in an air duct when the blade assembly 19 rotates is affected. Therefore, preferably, the angle θ between the line from one end of the projection of the protrusion portion 20 on the plane perpendicular to the rotation axis 103 of the blade assembly 19 to the projection of the rotation axis 103 on the plane and the line from the other end of the projection of the protrusion portion 20 on the plane to the projection of the rotation axis 103 on the plane is less than or equal to 180°. In an example, the angle θ between the line from one end of the projection of the protrusion portion 20 on the plane perpendicular to the rotation axis 103 of the blade assembly 19 to the projection of the rotation axis 103 on the plane and the line from the other end of the projection of the protrusion portion 20 on the plane to the projection of the rotation axis 103 on the plane is about 90°.

The above illustrates and describes basic principles, main features, and advantages of the present disclosure. It is to be understood by those skilled in the art that the preceding examples do not limit the present disclosure in any form, and technical solutions obtained through equivalent substitutions or equivalent transformations fall within the scope of the present disclosure

What is claimed is:

1. A lawn mower, comprising:
a blade configured to implement a cutting function;
a deck assembly formed with an accommodation cavity configured to at least partially accommodate the blade; and
a drive assembly comprising a drive shaft configured to drive the blade to rotate about a rotation axis;
wherein the deck assembly comprises:
a top wall formed with a through hole for the drive shaft to pass through;
a side wall connected to a periphery of the top wall; and
a protrusion portion at least partially disposed on the side wall and protruding from the side wall; and
wherein the blade has a blade tip farther from the rotation axis, a distance between the blade tip and the rotation axis is a cutting radius, a circular region with the rotation axis as a center and the cutting radius as a radius is defined as a cutting region, and a projection of the protrusion portion on a plane perpendicular to the rotation axis is at least partially located within a projection of the cutting region on the plane.

2. The lawn mower of claim 1, wherein a maximum width of an overlapping part of the projection of the protrusion portion on the plane and the projection of the cutting region on the plane is greater than or equal to 10 mm and less than or equal to 20 mm.

3. The lawn mower of claim 1, wherein a coordinate system is established on the plane, a projection of the rotation axis on the plane is an origin of the coordinate system, a first straight line extending along a front-and-rear direction is an x-axis of the coordinate system, a direction extending along the first straight line toward a rear side of the lawn mower is a positive direction of the x-axis, a second straight line extending along a left-and-right direction is a y-axis of the coordinate system, a direction extending along the second straight line toward a right side of the lawn mower is a positive direction of the y-axis, and the projection of the protrusion portion on the plane is located in a first quadrant and a fourth quadrant of the coordinate system.

4. The lawn mower of claim 3, wherein a maximum width of the projection of the protrusion portion on the plane in a direction of the x-axis is greater than or equal to 2% of a diameter of the accommodation cavity and less than or equal to 6% of the diameter of the accommodation cavity.

5. The lawn mower of claim 1, wherein the protrusion portion is located above the blade tip in a direction parallel to the rotation axis.

6. The lawn mower of claim 1, wherein a height difference between the protrusion portion and the blade tip is less than or equal to 10 mm.

7. The lawn mower of claim 1, wherein an angle between a line from one end of the projection of the protrusion portion on the plane to a projection of the rotation axis on the plane and a line from another end of the projection of the protrusion portion on the plane to the projection of the rotation axis on the plane is greater than or equal to 60° and less than or equal to 180°.

8. The lawn mower of claim 1, wherein the protrusion portion and the side wall are integrally formed.

9. The lawn mower of claim 1, wherein the deck assembly further comprises a grass outlet cover and a plug and the protrusion portion protrudes from the side wall, the grass outlet cover, and the plug.

10. The lawn mower of claim 9, wherein a part of the protrusion portion is integrally formed with the side wall, a part of the protrusion portion is integrally formed with the grass outlet cover, and another part of the protrusion portion is integrally formed with the plug.

11. A lawn mower, comprising:
a blade configured to implement a cutting function;
a deck assembly formed with an accommodation cavity configured to at least partially accommodate the blade, wherein the blade is capable of rotating around a rotation axis in the accommodation cavity; and
a drive assembly comprising a drive shaft configured to drive the blade to rotate about the rotation axis;
wherein the deck assembly comprises:
a top wall formed with a through hole for the drive shaft to pass through; and
a side wall connected to a periphery of the top wall; and
wherein a coordinate system is established on a plane perpendicular to the rotation axis, a projection of the rotation axis on the plane is an origin of the coordinate system, a first straight line extending along a front-and-rear direction is an x-axis of the coordinate system, a direction extending along the first straight line toward a rear side of the lawn mower is a positive direction of the x-axis, a second straight line extending along a left-and-right direction is a y-axis of the coordinate system, a direction extending along the second straight line toward a right side of the lawn mower is a positive direction of the y-axis, and a projection of a protrusion portion on the plane is located in a first quadrant and a fourth quadrant of the coordinate system.

12. The lawn mower of claim 11, wherein a maximum width of the projection of the protrusion portion on the plane in a direction of the x-axis is greater than or equal to 2% of a diameter of the accommodation cavity and less than or equal to 6% of the diameter of the accommodation cavity.

13. The lawn mower of claim 11, wherein the blade has a blade tip farther from the rotation axis, a distance between the blade tip and the rotation axis is a cutting radius, a circular region with the rotation axis as a center and the cutting radius as a radius is defined as a cutting region, the projection of the protrusion portion on the plane at least partially overlaps with a projection of the cutting region on the plane, and a maximum width of an overlapping part is greater than or equal to 10 mm and less than or equal to 20 mm.

14. The lawn mower of claim 13, wherein, in a direction parallel to the rotation axis, the protrusion portion is located above the blade tip and a height difference between the protrusion portion and the blade tip is less than or equal to 10 mm.

15. The lawn mower of claim 11, wherein an angle between a line from one end of the projection of the protrusion portion on the plane to the projection of the rotation axis on the plane and a line from another end of the projection of the protrusion portion on the plane to the projection of the rotation axis on the plane is greater than or equal to 60° and less than or equal to 180°.

16. A deck assembly of a lawn mower, comprising:
a top wall formed with a through hole; and
a side wall connected to a periphery of the top wall, wherein the top wall and the side wall surround an accommodation cavity and a blade of the lawn mower is capable of rotating around a rotation axis in the accommodation cavity;
wherein the deck assembly further comprises:
a protrusion portion and the protrusion portion is at least partially disposed on an inner side of the side wall, protrudes toward the rotation axis, and is located on a rear side of the deck assembly.

17. The deck assembly of claim 16, wherein a maximum thickness of the protrusion portion is greater than or equal to 2% of a diameter of the accommodation cavity and less than or equal to 6% of the diameter of the accommodation cavity.

18. The deck assembly of claim 16, wherein the protrusion portion and the side wall are integrally formed.

19. The deck assembly of claim 16, further comprising a grass outlet cover and a plug, wherein the protrusion portion protrudes from the side wall, the grass outlet cover, and the plug.

20. The deck assembly of claim 19, wherein a part of the protrusion portion is integrally formed with the side wall, a part of the protrusion portion is integrally formed with the grass outlet cover, and another part of the protrusion portion is integrally formed with the plug.
